(19) United States
(12) Patent Application Publication
(10) Pub. No.: US 2012/0248087 A1
(43) Pub. Date: Oct. 4, 2012

(54) WIND POWERED ELECTRIC FURNACE

(76) Inventor: James Hagan, Ira Township, MI (US)

(21) Appl. No.: 13/078,784

(22) Filed: Apr. 1, 2011

(51) Int. Cl. H05B 1/00; F27B 14/00

(52) U.S. Cl. 219/213; 219/420

(57) ABSTRACT

The present invention relates to methods and devices for generating heat for building structures or otherwise through wind power. In one exemplary embodiment, the present invention provides a wind powered electric furnace. The wind powered electric furnace includes a turbine disposed within a cavity of a first housing. The first housing defines a plurality of intake airflow paths having a narrowing profile in the direction of the cavity. The turbine is connected to a shaft. The wind powered electric furnace further includes a generator drivably connected to the shaft. The generator is adapted to generate electricity during rotation of the shaft. The wind powered electric furnace further includes an electric heater electrically connected to the generator, wherein upon rotation of the shaft electricity generated by the generator is transmitted to the electric heater.

### FIELD OF THE INVENTION

The present invention relates to methods and devices for generating heat for building structures or otherwise through wind power.

### BACKGROUND

Pollution, energy conservation and limited natural resources have lead companies and individuals to develop devices having reduced environmental impact, lower energy consumption and/or cost. Industries particularly sensitive to these considerations are companies involved in the production and delivery of energy, such as electricity and gas. Mostly, these industries have redeveloped existing electric and gas equipment to be more efficient. Alternatively, some companies have developed alternatives to typical energy production and/or delivery devices such as solar powered devices. However, many of these devices and alternatives are relatively expensive and/or impractical for certain applications.

In one particular aspect, remote building structures often lack the ability to generate electricity and heat due to the absence of utility systems. The remote structures must either go without such conveniences or rely on less conventional electric or heating means. Such power means may comprise wood or coal burning devices, propane heating systems or solar devices. However, these devices require the continual acquisition and delivery of fuel and/or costly purchase and installation of equipment. Further, such systems are impractical for smaller building structures.

In view of the foregoing, there is a need for improved production and delivery of low cost energy to building structures for the purpose of providing electricity and heat to the same. More so, there is a need to provide such energy to building structures remotely located or otherwise where energy cost is relatively high.

### SUMMARY OF THE INVENTION

The present invention relates to methods and devices for generating electricity and heat for building structures through wind power. The features of the present invention are predicated upon a device configured to harness and convert wind power to electricity, which is used to generated heat for a building structure. In one exemplary embodiment, the device is further configured to convert wind power to mechanical energy. In one configuration, the mechanical energy is used to drive a fan for circulating air within the building structure and more particularly across heating elements power through the electricity generated by the device.

In one exemplary embodiment, the present invention provides a wind powered electric furnace. The wind powered electric furnace includes a turbine disposed within a cavity of a first housing. The first housing defines a plurality of intake airflow paths having a narrowing profile in the direction of the cavity. The turbine is connected to a shaft. The wind powered electric furnace further includes a generator drivably connected to the shaft. The generator is adapted to generate electricity during rotation of the shaft. The wind powered electric furnace further includes an electric heater electrically connected to the generator, wherein upon rotation of the shaft electricity generated by the generator is transmitted to the electric heater.

In another exemplary embodiment, the present invention provides a wind powered electric furnace. The wind powered electric furnace includes a turbine assembly having a first housing defining a cavity, a plurality of intake airflow paths and at least one exhaust airflow path. The plurality of intake airflow paths are formed through an exterior wall of the first housing and define a narrowing airflow path from an exterior portion of the first housing to the cavity. The turbine assembly also includes a turbine including a plurality of vertically orientated vanes disposed within the first housing. The plurality of vanes have a concave portion and are disposed adjacent the plurality of intake airflow paths. The wind powered electric furnace further includes a shaft rotatably driven by the turbine. The heater further includes an electric generator including a positive magnetic member and a negative magnetic member. The positive magnetic member and the negative magnetic member are attached to the shaft. The electric generator further includes an electric winding disposed about the positive magnetic member and the negative magnetic member. The electric winding is disposed at a distance from the positive magnetic member and the negative magnetic member to allow for electrical induction upon rotation of the shaft. The wind powered electric furnace further includes a heater assembly having a second housing defining a second cavity, an air intake port and an air exhaust port. The heater assembly further include a resistant heater disposed within the cavity. The resistant heater includes a plurality of resistant heating elements having convection fins extending therefrom. The resistant heater being electrically connected to the electric winding to receive current therefrom during rotation of the shaft. The heater assembly also include a fan rotatably driven by the shaft and disposed within the second housing, wherein during rotation the fan draws cool air through the air intake, across the plurality of convection fins and out the air exhaust port.

In yet another exemplary embodiment, the present invention provides a heated building structure. The heated building structure includes a building structure defining an interior portion and exterior portion. The heated building structure further includes a turbine disposed proximate the exterior portion of the building structure. The turbine is disposed within a cavity of a first housing and is rotatably mounted to a shaft. The heated building structure further includes a generator drivably connected to the shaft. The generator is adapted to generate electricity during rotation of the shaft. The turbine also include an electric heater disposed within the building structure and electrically connected to the generator, wherein upon rotation of the shaft electricity generated by the generator is transmitted to the electric heater which acts to heat the interior portion of the building structure.

The above-described and other features and advantages of the present invention will be appreciated and understood by those skilled in the art from the following detailed description, drawings, and appended claims.

### BRIEF DESCRIPTION OF THE DRAWINGS

Other objects, features, advantages and details of the present invention appear, by way of example only, in the following detailed description of preferred embodiments of the invention, the detailed description referring to the drawings in which:

FIG. 1 illustrates a perspective view of an exemplary embodiment of a building structure and a wind powered electric furnace of the present invention;

FIG. 2 illustrates a perspective view of interior portion of the building structure and a wind powered electric furnace shown in FIG. 1;

FIG. 3 illustrates a perspective view of an exemplary embodiment of a building structure and a plurality of wind powered generators and a heating device of the present invention;

FIG. 4 illustrates a cross-sectional view of the exemplary building structure and wind powered electric furnace shown in FIG. 1; and

FIG. 5 illustrates another cross-sectional view of the exemplary building structure and wind powered electric furnace shown in FIG. 1.

### DESCRIPTION OF THE PREFERRED EMBODIMENTS

The present invention relates to methods and devices for the production and delivery of electrical and thermal energy to building structures. Such methods and devices are particularly advantageous for building structures being remotely located, however, such methods and devices may be utilized in most any building structure. In one aspect, the present invention provides a device for capturing wind power and converting it to electric power for various applications. In one particular aspect, the electricity generated is used to heat a room within a building structure.

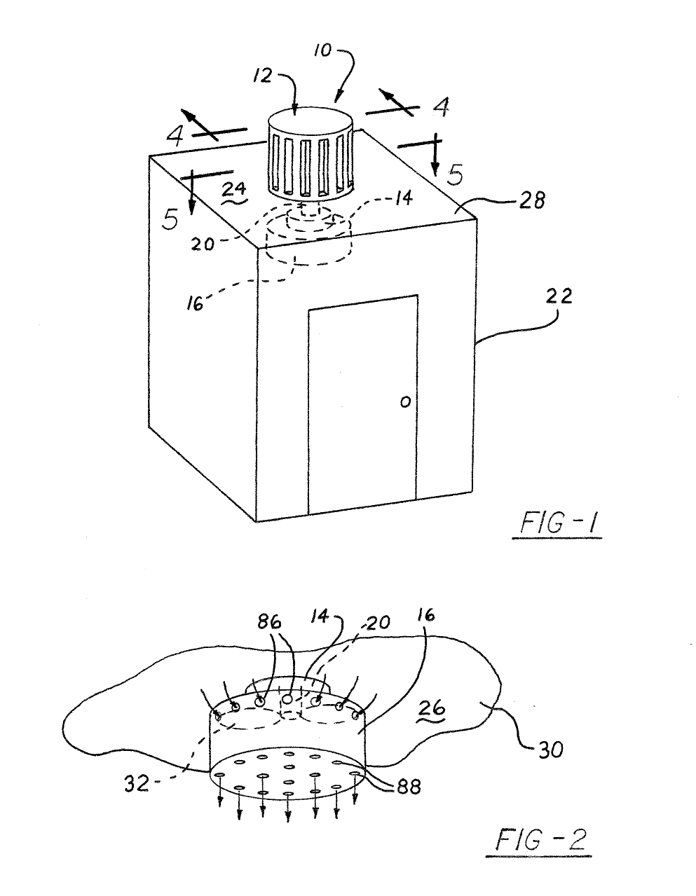

Referring to FIGS. 1 and 2, an exemplary embodiment of a wind powered electric furnace 10 is shown. The device includes a turbine assembly 12 in driving engagement with an electric generator 14. The electric generator 14 is in electrical communication with a heater assembly 16. In operation, wind passing through the turbine assembly 12 engages a turbine 18 causing rotation thereto. The turbine 18 is engaged with a shaft 20 that is in a driving relationship with the electric generator 14. Upon rotation of the shaft 20, the electric generator 14 generates electricity that is received by the heater assembly, wherein the electricity heats a resistant heater.

In the exemplary embodiment shown, the device 10 is attached to a building structure 22. The turbine assembly 12 is disposed proximate an exterior portion 24 of the building structure 22 and the heater assembly 16 is disposed proximate an interior portion 26 and within the building structure 22. The turbine assembly 12 is mounted directly or indirectly to a roof 28 of the building structure 22 and the heater assembly 16 is mounted directly or indirectly to a ceiling 30 or support structure thereof. In one exemplary embodiment, the heater assembly 16 further includes a fan 32 for distributing heated air from the heater assembly 16 throughout the interior portion of the building structure 22.

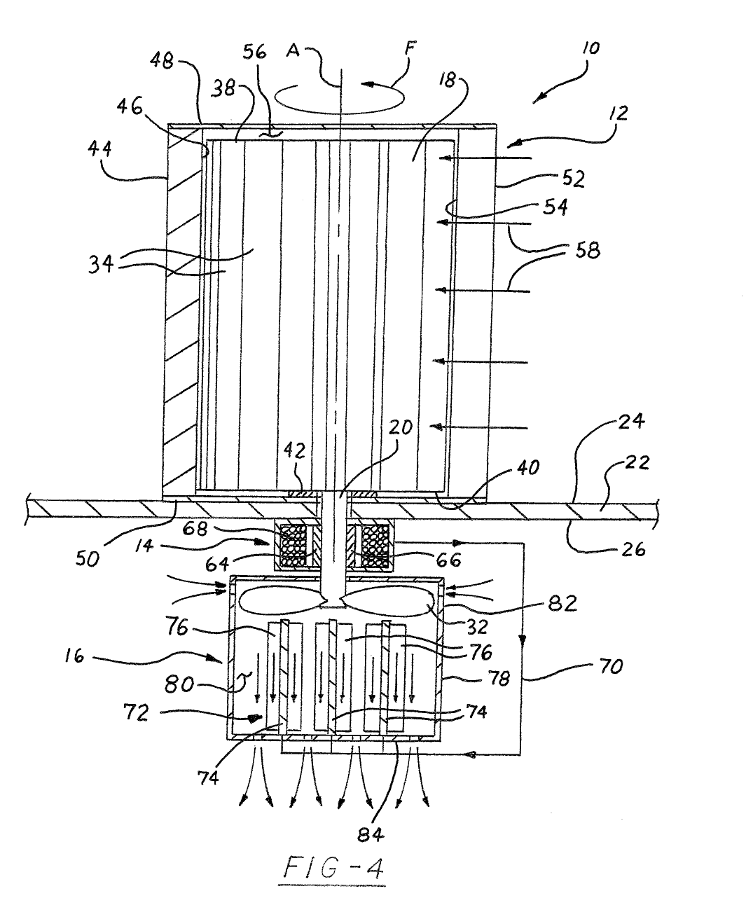

In greater detail, referring to FIG. 4, the turbine 18 includes a plurality of fin members 34 radially disposed about a rotational axis ‘A’ of the turbine 18 and shaft 20. The fin members 34 are generally vertically aligned and generally parallel with respect to the turbine axis ‘A’. In one exemplary embodiment, referring to FIG. 5, the plurality of fin members 34 includes a concave arcuate portion 36 extending the length of the fin members. Advantageously, the concave arcuate portions 36 are particularly orientated to capture wind flowing by the turbine. The plurality of fin members 34 are mounted to a top portion 38 and bottom portion 40 of the turbine 18. The turbine 18 is supported by a support bearing 42 which provides free rotation of the turbine. In one particular embodiment, the bottom portion 40 of the turbine is attached to the shaft 20, via suitable attachment means, or is otherwise connected to or in driving engagement with the shaft. In any regards, upon rotation of the turbine the shaft 20 is caused to rotate.

In one exemplary embodiment, referring to FIGS. 4 and 5, the turbine assembly 12 further includes a first housing 44 for housing components of the turbine assembly. The first housing 44 includes a housing wall 46 extending between a top housing member 48 and bottom housing member 50. The housing wall 46 defines an exterior portion 52 and an interior portion 54 of the first housing 44. The interior portion 54 of the first housing 44 defines a cavity suitable for receiving the turbine 18. The first housing 44 defines a plurality of intake airflow paths 58 and one or more, or plurality, of exhaust airflow paths 60. In one exemplary embodiment, the intake airflow paths 58 are defined by the housing wall 46 and extend between the top housing member 48 and bottom housing member 50. In one exemplary embodiment, the exhaust airflow paths are defined by the housing wall 46, opposite the air intake airflow paths. However, it is contemplated that the exhaust airflow path(s) may be formed through the housing wall 46, top housing member 48, bottom housing member 50 or combination thereof.

Referring particularly to FIG. 5, the fin members 34 of the turbine assembly 12 are disposed proximate the plurality of intake airflow paths such that air entering the first housing cavity 56 immediately engages the concave arcuate portions 36 of the fin members 34. In operation, as air enters the first housing 44, via the intake airflow paths 58, it engages the fine members 34 of the turbine assembly 12 causing the turbine 18 to rotate. Subsequently, air entering the first housing 44 exits the first housing 44 through the one or more exhaust airflow path(s) 60.

In one exemplary embodiment, still referring to FIG. 5, the plurality of intake airflow paths define a narrowing airflow path between the exterior portion 52 of the first housing 44 and the interior portion 54 or first housing cavity 56 of the first housing. Advantageously, the narrowing intake airflow path 58 increases the air velocity and pressure acting against the plurality of fin members 34. In one particular exemplary embodiment, the airflow paths 58 generate an airflow direction that is generally perpendicular to a portion of the concave arcuate portion 36 of the fin members 34. Also, in one particular exemplary embodiment, the end portion 62 of the fin members 34 are generally orientated parallel with respect to the airflow direction. Advantageously, this directional airflow and fin member 34 configuration provides increased rotational forces ‘F’ to the turbine 18.

Referring again to FIG. 4, the electric generator 14 is in driving relationship or otherwise receives the shaft 20. In one exemplary embodiment, as shown in FIG. 4, the electric generator 14 includes a positive magnetic member 64 and a negative magnetic member 66 disposed on shaft 20 or other rotating member connected thereto. The electric generator 14 further includes an electric winding, such as copper wire or otherwise, disposed about positive and negative magnetic members 64, 66, such that rotation of the magnetic members induce current in the electric winding. In another exemplary embodiment, it is contemplated that the electric winding may be attached to shaft 20, or other rotating member connected thereto, and the positive and negative magnetic members 64, 66 are disposed thereabout. In either regards, rotation of shaft 20 generates current, and particularly alternating current, within the electric winding 68.

The electric generator 14 is electrically connected to the heater assembly 16, via a suitable electric connection 70, to receive current therefrom. The heater assembly 16 includes a resistant heater 72 having one or more, or plurality, of resistant heating elements 74 configured to heat as a result of electricity flowing therethrough. In one exemplary embodiment, the heating elements 74 include convection fins 76 extending therefrom to facilitate in heat transfer from the heating elements and surrounding area.

In one exemplary embodiment, the heater assembly 16 includes a second housing 78 defining a second housing cavity 80 for housing components of the heater assembly 16 and in particular the resistant heater 72. The second housing 78 includes an exterior wall 82 and base portion 84 that define the second housing cavity 80. In one particular exemplary embodiment, the second housing 78 defines one or more, or plurality, of air intake ports 86 for receiving air into the second housing 78 and one or more, or plurality, of air exhaust ports 88 for egress of air within the second housing 78. The air intake port 86 and air exhaust port 88 allow for cycling of air, particularly heated air generated by the heater assembly 16, through the second housing 78.

As previously mention, the device 10 includes fan 32 for distributing heated air from the heater assembly 16 to a surrounding area. In one exemplary embodiment, the fan 32 is mechanically driven by rotating shaft 32. In another exemplary embodiment, the fan 32 is electrically driven by electric generator 14. In either configuration, it is contemplated that the fan 32 is positioned and configured to draw air into the second housing cavity 80 of the second housing 78, through the air intake ports 86, across the heating elements 74, and convection fins 76, and through the air exhaust ports 88.

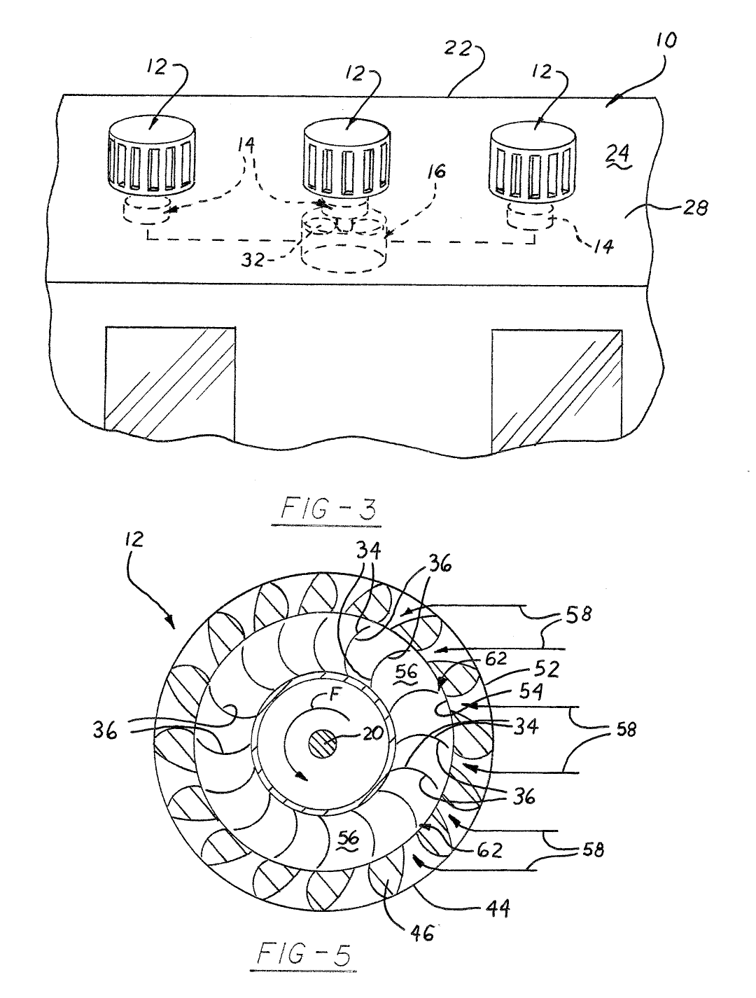

In one exemplary embodiment, referring to FIG. 3, it is contemplated that a plurality of turbine assemblies 12 are disposed on an exterior portion 24 of a building structure 22 for generating electricity. Each of the turbine assemblies 12 are in driving relationship with an electric generator 14. In one exemplary embodiment, one of the turbine assemblies 12 are driveably connected to a fan 32 disposed within the second housing 78 of a heater assembly 16. The heater assembly 16 includes a resistant heater 72 that is electrically connected to the electric generators 14 of the plurality of turbine assemblies 12.

In another exemplary embodiment, it is contemplated that the plurality of turbine assemblies and electric generators 14 may be used to power other electrical devices such as lighting or otherwise. Still further, it is contemplated that the electricity generated by the plurality of turbine assemblies and electric generators may be fed back into an electrical grid system of a utility company thereby reducing electric bills associated with the building structure the devices 10 are attached to.

The wind powered generator and heating device 10 may be used in various applications. In one particular application, the device 10 is used on a building structure 22 for capturing wind power on an exterior portion 24 of the building structure and provide heating to an interior portion 26 of the building structure. Such building structures 22 may comprise larger buildings such as office buildings, standing homes, motor homes, garages or otherwise. Such building structures 22 may also comprise smaller building structures such as ice shanties, ticket booths, out houses, small garages or otherwise.

With respect to smaller buildings such as shown in FIGS. 1 and 2, it is contemplated that a single device is used with a building structure 22. In this configuration, a single turbine assembly 12 is mounted proximate and exterior portion 24 of a building, which is linkably attached to the electric generator 14. Further, a single heater assembly 16 is mounted within the building structure 22. The power generated by the electric generator 14 is transmitted to the heater assembly 16 where it warms the interior of the building structure 22.

With respect to larger buildings, such as shown in FIG. 3, multiple turbine assemblies 12 are mounted proximate and exterior portion of a building structure. Each turbine assembly 12 is driveably connected to an electric generator 14. Electricity generated is transferred to a single heater assembly 16 which acts to heat an interior portion of the building structure. In one particular exemplary embodiment, the electricity generated by the electric generators 14 is used to further power the fan 32. In another particular exemplary embodiment, one of the turbine assemblies is used to drive the fan 32.

While the invention has been described with reference to a preferred embodiment it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims

1. A wind powered electric furnace, comprising:
a turbine disposed within a cavity of a first housing, the first housing defining a plurality of intake airflow paths having a narrowing profile in the direction of the cavity, the turbine being rotatably mounted to a shaft;
a generator drivably connected to the shaft, the generator being adapted to generate electricity during rotation of the shaft; and
an electric heater electrically connected to the generator, wherein upon rotation of the shaft electricity generated by the generator is transmitted to the electric heater.

2. The wind powered electric furnace of claim 1, wherein the turbine includes a plurality of vertically orientated vanes disposed about the shaft, the plurality of vanes have a concave portion and are disposed adjacent the plurality of intake airflow paths.

3. The wind powered electric furnace of claim 1, wherein the generator includes a positive magnetic member and a negative magnetic member disposed within an electrical winding, the positive magnetic member and the negative magnetic member are attached to the shaft such that upon rotation of the shaft an electric current is generated through the electrical winding.

4. The wind powered electric furnace of claim 1, wherein the electric heater is disposed within a cavity of a second housing, the second housing defines an air intake port and an air exhaust port.

5. The wind powered electric furnace of claim 4, wherein the second housing defines a plurality of air intake ports formed through an upper portion of the second housing and a plurality of air exhaust ports formed through a lower portion of the second housing.

6. The wind powered electric furnace of claim 5, wherein the electric heater comprises a resistant heater having a plurality of resistant heating elements, the plurality of resistant heating elements include one or more convection fins extending therefrom.

7. The wind powered electric furnace of claim 6, further comprising a fan disposed within the cavity of the second housing, wherein during rotation the fan draws air through the air intake, across the one or more convection fins and out the air exhaust port.

8. The wind powered electric furnace of claim 7, wherein the fan is rotatably driven by the shaft.

9. A wind powered electric furnace, comprising:
a turbine assembly including:
a first housing defining a cavity, a plurality of intake airflow paths and at least one exhaust airflow path, the plurality of intake airflow paths are formed through an exterior wall of the first housing and define a narrowing airflow path from an exterior portion of the first housing to the cavity,
a turbine including a plurality of vertically orientated vanes disposed within the first housing, the plurality of vanes have a concave portion and are disposed adjacent the plurality of intake airflow paths, and
a shaft rotatably driven by the turbine;
an electric generator including:
a positive magnetic member and a negative magnetic member, the positive magnetic member and the negative magnetic member are attached to the shaft, and
an electric winding disposed about the positive magnetic member and the negative magnetic member, the electric winding is disposed at a distance from the positive magnetic member and the negative magnetic member to allow for electrical induction upon rotation of the shaft; and
a heater assembly including:
a second housing defining a second cavity, an air intake port and an air exhaust port,
a resistant heater disposed within the cavity, the resistant heater includes a plurality of resistant heating elements having convection fins extending therefrom, the resistant heater being electrically connected to the electric winding to receive current therefrom during rotation of the shaft, and
a fan rotatably driven by the shaft and disposed within the second housing, wherein during rotation the fan draws cool air through the air intake, across the plurality of convection fins and out the air exhaust port.

10. A heated building structure, comprising:
a building structure defining an interior portion and exterior portion;
a turbine disposed proximate the exterior portion of the building structure, the turbine being disposed within a cavity of a first housing and being rotatably mounted to a shaft;
a generator drivably connected to the shaft, the generator being adapted to generate electricity during rotation of the shaft; and
an electric heater disposed within the building structure and electrically connected to the generator, wherein upon rotation of the shaft electricity generated by the generator is transmitted to the electric heater which acts to heat the interior portion of the building structure.

11. The building structure of claim 10, the first housing defines a plurality of intake airflow paths having a narrowing profile in the direction of the cavity,

12. The building structure of claim 11, wherein the turbine includes a plurality of vertically orientated vanes disposed about the shaft, the plurality of vanes have a concave portion and are disposed adjacent the plurality of intake airflow paths.

13. The building structure of claim 10, wherein the shaft extends through a roof of the building structure.

14. The building structure of claim 10, wherein the generator includes a positive magnetic member and a negative magnetic member disposed within an electrical winding, the positive magnetic member and the negative magnetic member are attached to the shaft such that upon rotation of the shaft an electric current is generated through the electrical winding.

15. The building structure of claim 10, wherein the electric heater is disposed within a cavity of a second housing, the second housing defines an air intake port and an air exhaust port.

16. The building structure of claim 15, wherein the second housing defines a plurality of air intake ports formed through an upper portion of the second housing and a plurality of air exhaust ports formed through a lower portion of the second housing.

17. The building structure of claim 16, wherein the electric heater comprises a resistant heater having a plurality of resistant heating elements, the plurality of resistant heating elements include a plurality of convection fins extending therefrom.

18. The building structure of claim 17, further comprising a fan disposed within the cavity of the second housing, wherein during rotation the fan draws air through the air intake, across the plurality of convection fins and out the air exhaust port.

19. The building structure of claim 18, wherein the fan is rotatably driven by the shaft.

20. The building structure of claim 10, wherein the first housing defines a plurality of intake airflow paths having a narrowing profile in the direction of the cavity and the turbine includes a plurality of vertically orientated vanes disposed about the shaft, the plurality of vanes have a concave portion and are disposed adjacent the plurality of intake airflow paths,
wherein the generator includes a positive magnetic member and a negative magnetic member disposed within an electrical winding, the positive magnetic member and the negative magnetic member are attached to the shaft such that upon rotation of the shaft an electric current is generated through the electrical winding,
wherein the electric heater is disposed within a cavity of a second housing, the second housing defines an air intake port and an air exhaust port and the electric heater comprises a resistant heater having a plurality of resistant heating elements, the plurality of resistant heating elements include a plurality of convection fins extending therefrom, and
further comprising a fan disposed within the cavity of the second housing, wherein during rotation the fan draws air through the air intake, across the plurality of convection fins and out the air exhaust port.
